(19) United States
(12) Patent Application Publication
(10) Pub. No.: US 2014/0333396 A1
(43) Pub. Date: Nov. 13, 2014

(54) METHOD FOR ADJUSTING A TRIPPING UNIT FOR A SAFETY SWITCH

(71) Applicant: Adolf Tetik, Wien (AT)

(72) Inventor: Adolf Tetik, Wien (AT)

(73) Assignee: EATON INDUSTRIES (AUSTRIA) GMBH, Schrems (AT)

(21) Appl. No.: 14/362,960

(22) PCT Filed: Dec. 10, 2012
(86) PCT No.: PCT/EP2012/074923

§ 371 Date: Jun. 5, 2014

(30) Foreign Application Priority Data
Dec. 9, 2011 (AT) A1806/2011

(51) Int. Cl. H01H 71/12; H01H 69/00; H01H 71/16

(52) U.S. Cl. CPC H01H 71/12; H01H 71/16; H01H 69/00
USPC 335/35; 29/593

(57) ABSTRACT

A method for adjusting a tripping unit for a safety switch, wherein the tripping unit has a first current path as pan of a magnetic tripping device, and wherein the tripping unit has a second current path as part of a bimetallic tripping device. According to the invention, a specifiable test current is applied to the tripping unit, a partial current in one of the two current paths is measured, and a cross-section at one of the two current paths is reduced on the basis of the magnitude of the measured partial current.

### CROSS-REFERENCE TO RELATED APPLICATIONS

This application is a U.S. National Stage application under 35 U.S.C. §371 of International Application No. PCT/EP2012/074923, filed on Dec. 10, 2012, and claims benefit to Austrian Patent Application No. A1806/2011, filed on Dec. 9, 2011. The International Application was published in German on Jun. 13, 2013, as WO 2013/083831 A1 under PCT Article 21(2).

### FIELD

The invention relates to the adjustment procedure of a trigger unit for a switching device.

### BACKGROUND

There are switching devices with two triggers available, whereby one of the two triggers is devised as a magnetic trigger, specifically as an electromagnetic trigger, and the other trigger is devised as a thermal trigger usually comprising a bimetal part. The magnetic trigger triggers the circuit breaker in case of a short-circuit, and the thermal trigger triggers the circuit breaker in case of overcurrent. Thereby the tripping characteristics in case of overcurrent must comply with clearly defined specifications. While the magnetic trigger does not often require additional adjustment, the thermal overcurrent trigger usually requires adjustment, because small manufacturing and/or material tolerances can have an effect on the triggering operation. For that matter, the completely assembled switching device is tested in a testing device with high currents, and the bimetal part is adjusted manually using an adjustment screw. It is detrimental in this procedure that the procedure merely offsets the foot and/or fixing point of the bimetal part. Rudimental adjustment is only possible with this procedure; and the procedure furthermore involves significant costs. The actual characteristics of the bimetal part cannot be influenced in this manner Furthermore, the procedure can only be applied in case of a complete and finished circuit breaker. If the tester finds that the circuit breaker cannot be adjusted to comply with the requirements on triggering for example due to the limited adjustment range, the entire circuit breaker is scrapped and it must be destroyed. Due especially to the fact that the electrical characteristics of welded joints can turn out very differently, the conventional adjustment range available is often insufficient.

### SUMMARY

An aspect of the invention provides a process for adjusting and assembling a trigger unit into a switching device, the process comprising: applying a predetermined test current to a trigger unit, the trigger unit including a first current path part of a magnetic trigger, and a second current path part of a bimetal trigger; measuring a partial current in one of two current paths of the trigger unit; reducing a cross-section of the first or the second current path as a function of a measured value of the partial current; and adjusting the trigger unit prior to assembling the trigger unit into the switching device.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 a first embodiment of a trigger unit for a switching device in a first axonometric view;

FIG. 2 the trigger unit according to FIG. 1 in a second axonometric view; and

FIG. 3 a second embodiment of a trigger unit of a switching device in axonometric view.

### DETAILED DESCRIPTION

An aspect of this invention provides a procedure to avoid the aforesaid detriments and to provide a simple and precise adjustment procedure of the trigger unit and to reduce production costs.

An aspect of the invention ensures a simple and precise adjustment procedure of the trigger unit. Thereby the trigger unit can be thoroughly tested in the manufacturing phase prior to the assembly into the switching device. Thereby the triggering characteristics of the affected leg can be better adjusted. Thereby, even if the trigger unit cannot be adjusted, the entire switching device is not wasted and thus production costs are reduced.

An aspect of the invention relates to a switching device.

An aspect of this invention provides a switching device as specified above to avoid the aforesaid detriments and ensuring reliable triggering characteristics especially in case of overcurrent, and which involves reduced production costs.

This results in a reduction of production costs, because even if the trigger unit cannot be adjusted, the entire switching device is not wasted. Such a switching device has a precisely adjustable trigger unit and it has reliable triggering characteristics especially in case of overcurrent.

Reference to the wording of the claims is expressly made here, whereby the claims are included at this point by reference in the description and are reproduced word for word.

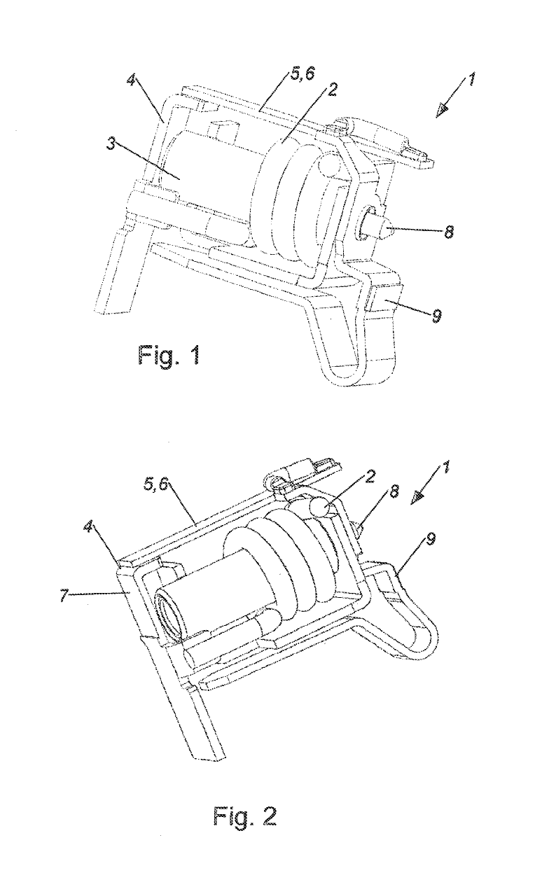

FIGS. 1 to 3 show two different embodiments of a trigger unit 1 of a switching device, whereby the trigger unit 1 has a first current path 2 in the form of a magnetic trigger, and whereby the trigger unit 1 has a second current path 4 part of a bimetal trigger 5, whereby one of the two current paths 2, 4 has at least one area 7 with a reduced cross-section.

This results in a reduction of production costs of the switching device, because even if the trigger unit 1 cannot be adjusted, the switching device is not completely wasted. Such a switching device is further fitted with a precisely adjustable trigger unit 1 and it has reliable triggering characteristics especially in case of overcurrent.

A switching device is an electric circuit breaker, devised for the purpose of disconnecting one or several electrical contacts under specific conditions. A switching device devised for example as a miniature circuit breaker or a circuit breaker is fitted with switching contacts and usually with a so-called switch mechanism. This is a mechanical device which controls the movement and/or position of the switching contacts. The switching device is further fitted with a trigger unit 1.

A trigger unit 1 of a switching device is a component devised for the purpose of inducing or causing respectively the disconnection or opening of the switching contacts under specific conditions. According to the present invention, the purpose of trigger unit 1 is to open the switching contacts in case of an increased current flow caused specifically by a short-circuit or overcurrent through the switching device.

For this purpose, the trigger unit 1 is fitted with a first current path 2, which is part of a magnetic trigger 3. The magnetic trigger, which can also be deemed an electromagnetic trigger, comprises preferably a coil; and a movable anchor is stored in the coil. In case of short-circuit and thus a significantly increased current flow, the coil generates a magnetic field, and this causes the movement of the anchor and of a trigger slide 8 connected to this anchor respectively. The trigger slide further touches a part of the switching device, especially a part of the switch mechanism, which causes the switching device to trigger and it results in disconnecting the switching contacts.

The trigger unit 1 is further fitted with a second current path 4, which is part of a bimetal trigger 5, which can also deemed a thermal trigger unit. The bimetal trigger 5 comprises at least a bimetal part 6, and either the current flows directly through the bimetal part or this part is located in the immediate vicinity of a current-carrying conductor. The bimetal part 6 bends due to the heat generated by the current flowing through the conductor or through the bimetal part. If the current flow increases and it exceeds by an adjustable amount the value of a nominal current, the switching device was dimensioned and approved for, the bimetal part 6 bends to such a degree, that the switching device is tripped. The switching device should trigger after different duration of the current flow in function of the current strength.

According to the preferred embodiment presented, a trigger unit 1 is designed to have the first current path 2 and the second current path 4 connected in parallel. This helps to devise a trigger unit 1 with a compact and enclosed design, which can be easily checked.

According to the adjustment procedure of a trigger unit 1 of a switching device, whereby the trigger unit 1 has a first current path 2 part of a magnetic trigger 3, and whereby the trigger unit 1 has a second current path 4 part of a bimetal trigger 5; a predetermined test current is applied to the trigger unit 1, and a partial current is measured in one of the two current paths 2, 4, and the cross-section of one of the two current paths 2, 4 is reduced in function of the partial current flow measured to set the desired ratio of the two partial current flows as compared to each other.

This ensures a simple and precise adjustment procedure of the trigger unit 1. Thereby the triggering characteristics of the affected leg can be better adjusted. Thereby the trigger unit 1 can be thoroughly tested in the manufacturing phase prior to assembly in the switching device. It is particularly preferred that the trigger unit 1 is adjusted prior to its assembly in a switching device. Thereby, even if the trigger unit 1 cannot be adjusted for example due to manufacturing flaws, the entire switching device is not wasted and thus total production costs are reduced.

A further advantage of the present procedure is the high degree of automation capabilities.

By reducing the cross-section, the resistance of one of the two current paths 2, 4 increases, and thus the ratio of the two partial currents changes. Each of the two current paths 2, 4 can be adjusted in this manner.

There are different procedures available for the reduction of the cross-section. For example, an area of the relevant current path 2, 4 can be stretched and/or notched using a ductile procedure to reduce the cross-section in this manner. Preferably the cross-section of the relevant current path 2, 4 is reduced in a machining procedure, preferably by milling or cutting. This ensures a highly sensitive adjustment procedure. In an easy procedure, the cross-section is slightly adjusted in a first step followed by testing the trigger unit 1 again using a test current and performing subsequent machining if necessary.

According to a preferred embodiment of the present procedure, the amount for the rate of reduction of the cross-section is determined based on the amount of partial current flow measured. The cross-section is reduced based on the value determined in an earlier step. Especially in case of mass production, the precision attainable ensures that adjustment is performed in only one such adjustment procedure.

The cross-section of one of the two current paths 2, 4 can also be reduced during the measurement of the partial current flow, which ensures that the trigger unit 1 is adjusted extremely precisely and quickly.

Preferably prior the performance of the adjustment procedure, the corresponding trigger unit 1 has at least one of its current paths, or a part of the current path over-dimensioned to a predefined specific degree to ensure that the cross-section can be reduced accordingly.

The cross-section of both of the two current paths 2, 4 can be possibly adjusted. Preferably the cross-section of the second current path 4 is adjusted. This ensures a better impact on the area of the trigger unit which is more sensitive with respect to adjustments.

Preferably, as presented in the figures, the cross-section of the second current path 4 is reduced at a section of the conductor outside of the bimetal part 6. This provides the benefit of lower material costs. The cross-section of a bimetal part 6 of the bimetal trigger 5 can also be adjusted. This ensures further opportunities for the modification of the geometry of the bimetal part 6 to influence the triggering characteristics of the trigger unit 1.

FIGS. 1 and 2 show a first preferred embodiment of a trigger unit 1. This comprises two active conductors, preferably copper conductors, which are connected to the coil of the magnetic trigger 3 and to the bimetal part 6. The coil of the bimetal part 6 is thereby connected in parallel. Current flows directly through the bimetal part 6. The fixed contact 9 of a switching device is devised at one of the active conductors. The respective active conductor is therefore part of the current flow through the circuit breaker which comprises the trigger unit 1. FIG. 2 shows the area 7 with the reduced cross-section of the second current path 4. The cross-section is formed by milling a part of the respective active conductor. The shape of the respective area 7 with the reduced cross-section determines generally the production technology used for manufacturing the respective shape.

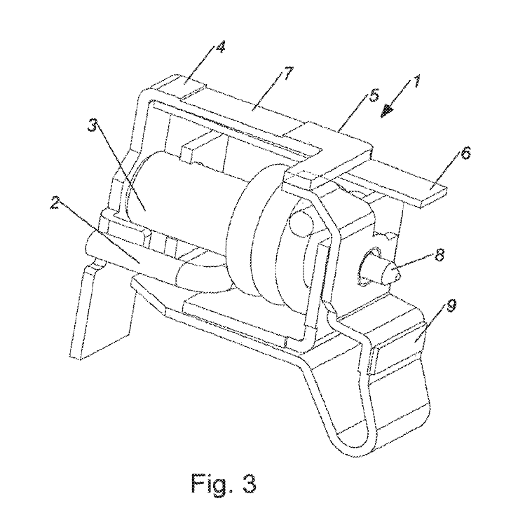

FIG. 3 shows a second preferred embodiment of a trigger unit 1. Unlike the first embodiment according to FIGS. 1 and 2, current does not flow through the bimetal part 6. Bimetal part 6 is thereby fixed to a conductor area of the second current path 4, particularly by welding, and it is heated indirectly by the heat discharged by the respective conductor area. The second preferred embodiment of a trigger unit 1 has an area 7 with a reduced cross-section at the respective conductor area. By placing the area 7 with a reduced cross-section at the conductor area, which is placed near and in parallel with the bimetal part 6, the heating of the conductor area and the exact location of this heating effect can be controlled precisely. Therefore the area of the bimetal part 6 heated and the degree to which it is heated can be specified with high precision.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

1. A process for adjusting and assembling a trigger unit into a switching device, the process comprising:
applying a predetermined test current to a trigger unit, the trigger unit including a first current path part of a magnetic trigger, and a second current path part of a bimetal trigger;
measuring a partial current in one of the two current paths of the trigger unit;
reducing a cross-section of one of the first or the second current path as a function of a measured value of the partial current; and
adjusting the trigger unit prior to assembling the trigger on into the switching device.

2. The process of claim 1, the reducing of the cross-section occurs in a machining procedure.

3. The process of claim 1, wherein the cross-section of the second current path is reduced.

4. (canceled)

5. The process of claim 1, further comprising:
determining an amount for a rate of reduction of the cross-section is based on the meat measured value of the partial current.

6. The process of claim 1, wherein the cross-section of first or second current path is reduced while the partial current is measured.

7. The process of claim 1, wherein the cross-section of a bimetal part of the bimetal trigger is reduced.

8. A switching device, comprising:
a trigger unit,
wherein the trigger unit includes a first current path in the form of a magnetic trigger,
wherein the trigger unit includes a second current path as part of a bimetal trigger,
wherein the first or the second current path has at least one area with a reduced cross-section, and
wherein the first current path and the second current path are connected in parallel.

9. The device of claim 8, wherein the second current path has the area with the reduced cross-section.

10. The device of claim 8, wherein the area with the reduced cross-section is shaped by milling, cutting, or milling and cutting.

11. (canceled)

12. The device of claim 8, in the form of a miniature circuit breaker.

13. The process of claim 1, wherein the reducing comprises milling.

14. The process of claim 1, wherein the reducing comprises cutting.

15. The process of claim 13, wherein the reducing comprises cutting.
